(19) United States
(12) Patent Application Publication
(10) Pub. No.: US 2017/0019945 A1
(43) Pub. Date: Jan. 19, 2017

(54) Dual Connectivity Re-Establishment

(71) Applicant: Nokia Solutions and Networks Oy, Espoo (FI)

(72) Inventors: Tsunehiko Chiba, Saitama (JP); Srinivasan Selvaganapathy, Bangalore (IN)

(21) Appl. No.: 15/124,143

(22) PCT Filed: Mar. 21, 2014
(86) PCT No.: PCT/EP2014/055670

§ 371 Date: Sep. 7, 2016

(51) Int. Cl. H04W 76/02; H04W 74/08

(52) U.S. Cl. CPC H04W 76/028; H04W 76/025; H04W 74/0833; H04W 88/06

(57) ABSTRACT

An apparatus and method are provided. A request for re-establishment of a connection is received at a primary access node. A request for configuration information is sent to a secondary access node in response to the request for re-establishment.

### FIELD

The present application relates to a re-establishment procedure and in particular but not exclusively to a re-establishment procedure in systems implementing dual connectivity.

### BACKGROUND

A communication system may be seen as a facility that enables communication sessions between two or more nodes such as fixed or mobile communication devices, access points such as nodes, base stations, servers, hosts, machine type servers, routers, and so on. A communication system and compatible communicating devices typically operate in accordance with a given standard or specification which sets out what the various entities associated with the system are permitted to do and how that should be achieved. For example, the standards, specifications and related protocols may define the manner how communication devices shall communicate with the access points, how various aspects of the communications shall be implemented and how the devices and functionalities thereof shall be configured.

An example of cellular communication systems is an architecture that is being standardized by the 3rd Generation Partnership Project (3GPP). A recent development in this field is often referred to as the long-term evolution (LTE) or long-term evolution advanced (LTE advanced) of the Universal Mobile Telecommunications System (UMTS) radio-access technology. In LTE base stations providing the cells are commonly referred to as enhanced NodeBs (eNB). An eNB may provide coverage for an entire cell or similar radio service area.

A user may access the communication system by means of an appropriate communication device. A communication device of a user is often referred to as user device (UE), user device or terminal. A communication device is provided with an appropriate signal receiving and transmitting arrangement for enabling communications with other parties. In wireless systems a communication device typically provides a transceiver station that may communicate with another communication device such as e.g. a base station. A communication device such as a user device (UE) may access a carrier provided by a base station, and transmit and/or receive on the carrier.

Capacity of a communication system may be improved by providing network densification—increasing a number of network nodes and decreasing an average distance between user equipment and network nodes. One method of increasing densification of a network is to provide smaller nodes (for example low power nodes) under the control of more powerful macro nodes. The smaller nodes may provide the network with an increased traffic capacity while the macro nodes may provide service availability for the coverage area.

In dual connectivity, a user equipment may operate in a system having both macro nodes and small nodes and may carry out simultaneous (dual) communication with a macro and a small node. The functionality of the macro and small nodes may be arranged in different ways, for example control signalling may be carried out through the macro node while data signalling may be carried out through the small node and/or uplink and downlink connectivity may be separated between the macro and small node.

Connection re-establishment is carried out for a user equipment when a connection has failed, for example in the case of a failed handover and/or due to a radio link failure. In connection re-establishment, a link between a user equipment and serving node is re-established and then reconfiguration may be carried out to re-establish the radio bearers for the communication.

In the case of dual connectivity network this re-establishment may become more complicated.

Embodiments of the present application aim to address the re-establishment procedure in dual connectivity networks.

### SUMMARY

According to a first aspect, there is provided a method comprising: receiving at a primary access node a request for re-establishment of a connection; and sending to a secondary access node a request for configuration information in response to the request for re-establishment.

The request for re-establishment may be received from a user equipment. Sending the request for configuration information may be triggered by the receiving the request for re-establishment.

The method may further comprise: sending a request for connection reconfiguration to the user equipment from the primary access node, the request for connection reconfiguration comprising the configuration information of the secondary access node The method may further comprise: receiving an indication from the user equipment that re-establishment is complete before sending the request for connection reconfiguration.

Sending the request for configuration information to the secondary access node may further comprise: sending the secondary access node an indication that a request for re-establishment has been received. The request for re-establishment may be a radio resource control connection re-establishment request. The indication may be sent in a secondary cell group modification request message. The request for connection reconfiguration may be a radio resource control connection reconfiguration request. The configuration information may comprise the configuration parameters of the secondary access node that are required for a random access procedure between the user equipment and the secondary access node.

The method may further comprise: updating stored configuration information for the secondary access node with the configuration information received from the secondary access node. In response to receiving the request for re-establishment the method may further comprise: disabling forwarding of data packets by the primary access node.

In response to receiving the request for configuration information the method may further comprise: disabling forwarding of data packets by the secondary access node.

According to a second aspect, there may be provided a network access node comprising at least one processor and a memory, the at least one processor and memory configured to: receive a request for re-establishment of a connection; and send to a secondary access node a request for configuration information in response to the request for re-establishment.

The network access node may be further configured to: send a request for connection reconfiguration to a user equipment, the request for connection reconfiguration comprising the configuration information of the secondary network access node

According to a third aspect, there is provided a method carried out by a secondary access node comprising: receiving from a primary access node, an indication that a request for re-establishment of a connection has been received at the primary access node from a user equipment; and sending configuration information of the secondary access node to the primary access node.

The configuration information may comprise configuration parameters of the secondary access node that are required for a random access procedure between a user equipment and the secondary access node. The indication may form part of a secondary cell group modification request message and the configuration information is sent in a secondary cell group modification response message.

The method may further comprise: scheduling data communication in response to an indication that a reconfiguration procedure between a user equipment and the secondary access node is complete.

According to a fourth aspect, there may be provided a network access node comprising at least one processor and a memory, the at least one processor and memory configured to: receive from a primary access node, an indication that a request for re-establishment of a connection has been received at the primary access node from a user equipment; and send configuration information of the secondary access node to the primary access node.

According to a fifth aspect, there is provided a method comprising: sending a request for re-establishment of a connection to a primary network access node and carrying out a re-establishment procedure with the primary network access node; receiving a connection reconfiguration request from the primary access node, the connection reconfiguration request comprising configuration information for a secondary network access node.

The method may further comprise: carrying out a random access procedure with the secondary network access node in dependence on the configuration information of the secondary network access node. The method may further comprise: performing a first random access procedure using stored parameters at the user equipment before receiving the connection configuration request from the primary network access node.

The method may further comprise: comparing the configuration information of the secondary network access node received in the connection reconfiguration request to the stored parameters; and when the stored parameters and the received configuration information match resume communication with the secondary network access node based on the random access procedure.

The method may further comprise performing a second random access procedure when the stored parameters and the received configuration information do not match.

The method may further comprise: storing information corresponding to a first primary and secondary network access node; determining that a link with the first primary and secondary network access node has failed; sending a request for re-establishment of a connection to a second primary and secondary node; and when the first primary network access node matches the second primary network access node, carry out the first random access procedure.

According to a sixth aspect, there is provided an apparatus comprising at least one processor and a memory, the at least one processor and memory configured to: send a request for re-establishment of a connection to a primary network access node and carrying out a re-establishment procedure with the primary network access node; and receive a connection reconfiguration request from the primary access node, the connection reconfiguration request comprising configuration information for a secondary network access node.

The apparatus may be further configured to: carry out a random access procedure with the secondary network access node in dependence on the configuration information of the secondary network access node. The apparatus may be further configured to: perform a first random access procedure using stored parameters at the user equipment before receiving the connection configuration request from the primary network access node.

According to a seventh aspect, there is provided a system comprising: a user equipment configured to send a request for re-establishment of a connection to a primary access node; the primary access node configured to send a request for configuration information to a secondary access node in response to the request for re-establishment; and the secondary access node configured to send configuration information to the primary access node in response to the request configuration information.

The user equipment may be further configured to carry out a random access procedure with the secondary access node based on stored configuration information before a response to the request for re-establishment has been received. The primary access node may be configured to provide the configuration information of the secondary access node to the user equipment in a request for reconfiguration.

The user equipment may be configured to communicate with the secondary access node based on the random access procedure when the configuration information matches the stored configuration information. The user equipment may be configured to carry out a further random access procedure with the secondary network node when the received configuration information does not match the stored configuration information.

### BRIEF DESCRIPTION OF DRAWINGS

Embodiments of the present application will now be described with reference to the following figures in which:

FIG. 1 shows an example of a telecommunications system in which embodiments may be implemented;

FIG. 2 is a schematic diagram showing an example of a user equipment that may be used in some embodiments;

FIG. 3 is a schematic diagram showing an example of an apparatus that may be used in some embodiment;

FIG. 4 is a signalling diagram showing an example of the signalling carried out in a handover procedure;

FIG. 5 is a flow diagram showing an example of the method steps that may be carried out by a primary access node in some embodiments;

FIG. 6 is a flow diagram showing an example of the method steps that may be carried out by secondary access node in some embodiments;

FIG. 7 is a flow diagram showing an example of the method steps that may be carried out by a user equipment according to some embodiments;

FIG. 8 is a signalling diagram showing an example of the signalling in a re-establishment procedure according to an embodiment; and

FIG. 9 is a signalling diagram showing an example of the signalling in a re-establishment procedure according to a further embodiment.

### DETAILED DESCRIPTION

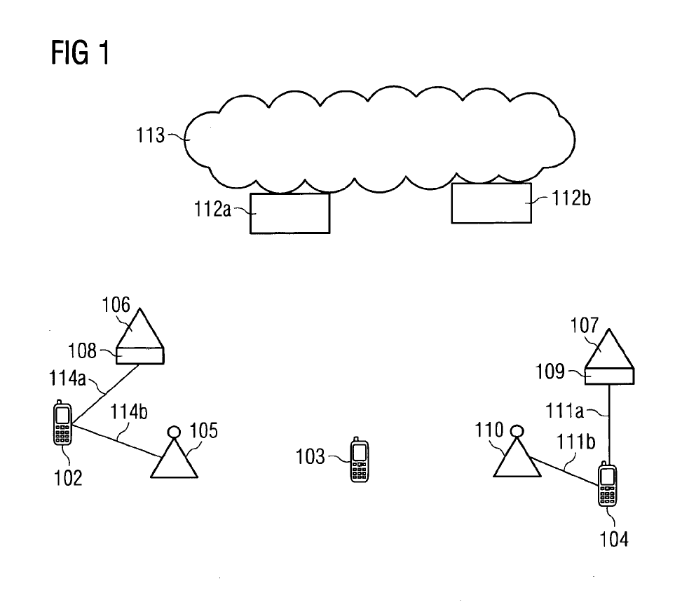

Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipment (UE) 102, 103, 104 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be part of the base station and/or provided by a separate entity such as a Radio Network Controller. In FIG. 1 control apparatus 108 and 109 are shown to control the respective macro or master level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 the master base station 106 is shown as connected to a wider communications network 113 via gateway 112a and the master base station 107 is shown as connected to a wider communications network 113 via gateway 112b. A further gateway function may be provided to connect to another network in some examples.

The smaller or secondary base stations 110 and 105 may also be connected to the network 113, for example via the gateways 112a and 112b and/or via the controllers 108, 109 of the macro level stations 106, 107. In the example, secondary base station 105 may be connected to the network via the controller 108 of the master base station 106 and/or may be connected via the gateway 112a. The secondary base station 110 may be connected to the network via the controller 109 of the master base station 107 and/or may be connected via the gateway 112b. The secondary base stations may for example be provided by a pico cell, a micro cell, and/or the like.

The communication system may support the user equipment 102 being in simultaneous communication with the base station 106 and the second base station 105. Similarly the use equipment 104 may be supported being in simultaneous communication with the secondary base station 110 and the master base station 107. The communication may thus support dual connectivity.

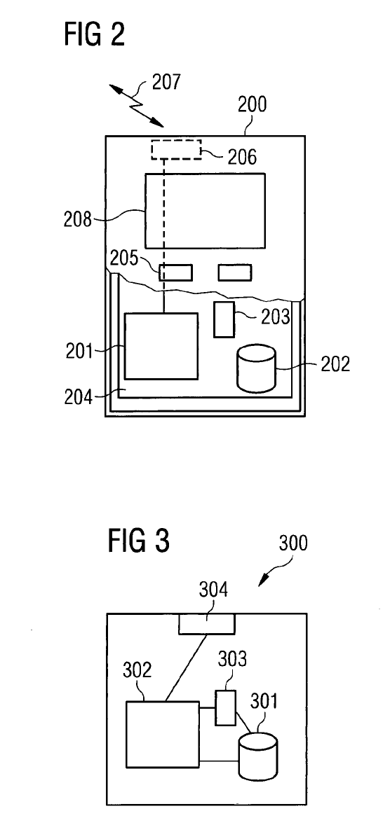

A possible communication device will now be described in more detail with reference to FIG. 2 showing a schematic, partially sectioned view of a communication device 102. Such a communication device is often referred to as user equipment (UE) or terminal. An appropriate communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The device 102 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the device.

A device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the device by means of a suitable user interface such as key pad 205, voice commands, touch sensitive screen or pad, combinations thereof or the like. A display 208, a speaker and a microphone can be also provided. Furthermore, a communication device may comprise appropriate connectors (either wired or wireless) to other devices and/or for connecting external accessories, for example hands-free equipment, thereto.

The communication devices 102, 103, 104 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

When the dual connectivity network of FIG. 1 is implemented in accordance with LTE, there may be an S1-MME/S1-U air interface between the gateway 112a and 112b and the master bases station 106, 107 respectively. The interface between the gateway 112a, 112b and secondary base stations 105, 110 may be an S1-U interface. An X2 interface may be provided between the secondary base station 105, 105 and master base station 106, 107 respectively and between two master base stations 106, 107.

FIG. 3 shows an example of a control apparatus. The control apparatus comprises at least one memory 301, at least one data processing unit 302, 303 and an input/output interface 304. Via the interface the control apparatus can be coupled to receive and/or transmit data. For example the control apparatus can be configured to execute an appropriate software code to provide the control functions. The control apparatus may be provided in one or more of master base station, a secondary base station and any other suitable control entity.

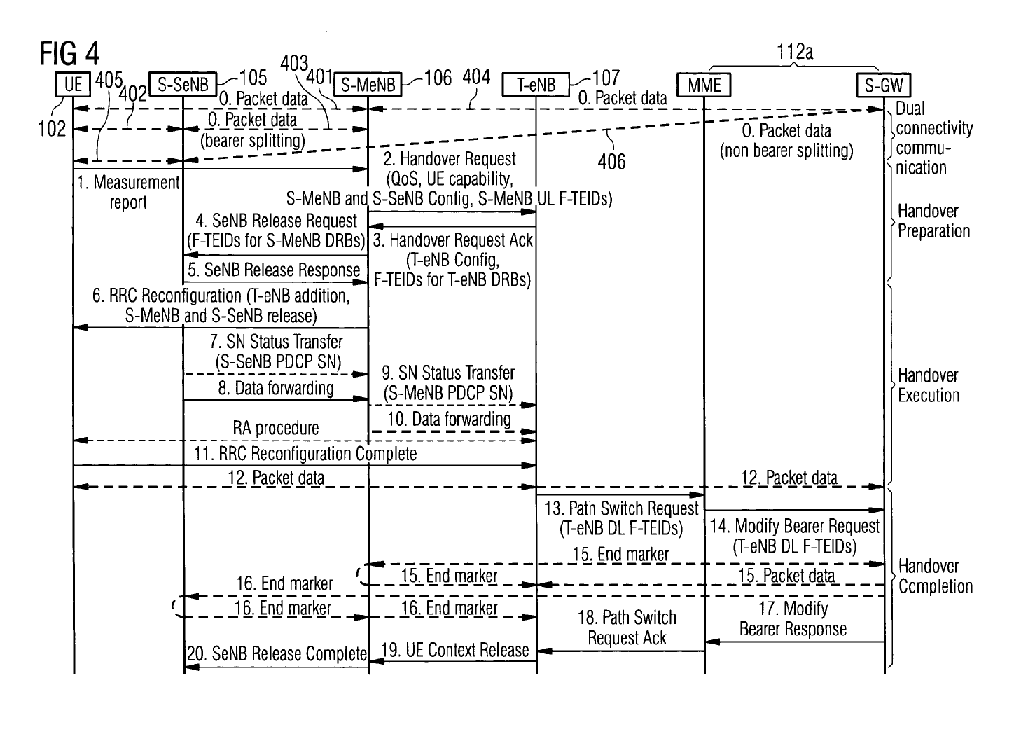

In the foregoing, a user equipment is depicted as being in communication (or connected to) a master base station and secondary base station simultaneously. It will be appreciated that this may be in accordance with a dual connectivity network. At some point during this communication, it may be desired to hand a user equipment over from one master base station (a source master base station) to another master base station (a target master base station). This may be due to for example signal strength experienced by the user equipment (UE) and/or the movement of the UE in the geographical area in which the communication system is deployed. FIG. 4 is a signalling diagram showing the signalling carried out between network entities in order to carry out a handover of a UE from the source master base station to the target master base station.

FIG. 4 shows UE 102, serving secondary base station (S-SeNB) 105, serving master base station (S-MeNB) 106, target master base station (T-MeNB) 107 and mobility management entity (MME) and serving gateway (S-GW) 112a. It will be appreciated that in some embodiments, the MME and S-GW may be combined.

The signalling 401 to 406 shows an example of a dual connectivity of a UE 102 with the secondary and master base stations 105 and 106. In a first example (401 to 404) the dual connectivity implements bearer splitting. A bearer being the radio access network resource used to carry data traffic between the UE 102 and wider network.

In bearer splitting, the UE may transmit and receive user plane data along two paths. A first path may be directly between the UE 102 and the S-MeNB 106 and a second path may be between the UE 102 and S-MeNB 106 via the S-SeNB 105. For example, at step 402 first traffic or data generated at the UE 102 is provided to the S-SeNB 105 which then provides the first traffic or data to the S-MeNB 106 at step 403. Second traffic or data is provided directly to the S-MeNB 106 at 401. The S-MeNB 106 may provide the first and second data to the S-GW 112a.

In non-bearer splitting, the S-SeNB 105 may send data from the UE 102 directly to the MME/S-GW 112a without the data going via the S-MeNB 106. This can be seen at step 405 showing the communication between the UE 102 and the S-SeNB 105 and step 406 where the packet data is provided between the S-SeNB 105 and the MME/S-GW 112a.

The packet data may thus be transferred between MME/S-GW 112a and the UE 102 by passing through S-MeNB 105 (steps 401 and 404), passing through the S-MeNB 106 and the S-SeNB 105 (steps 402, 403 and 404) or passing through the S-SeNB only (steps 405 and 406) depending on the user-plane option (bearer splitting or non bearer splitting) in dual connectivity mode.

It will be appreciated that in some point in the dual connectivity of the UE 102, it may be decided for the UE 102 to be handed over from the source MeNB 105 to the target MeNB 106. In order to facilitate handover decisions, a UE may periodically or in response to an event or trigger generate a measurement report. The measurement report may be generated for example when a signal strength at the UE 102 fells below a threshold value.

At step 1, a measurement report is triggered and sent to the S-MeNB 106. The measurement report 1 may be transmitted from the UE 102 to the serving base station, in this case the S-MeNB 106. The S-MeNB 106 may then select a target base station with which to perform handover based at least partly on the measurement report. In this example, the S-MeNB 106 selects the T-eNB 107 for handover.

The S-MeNB 106 may send a handover request message to a target MeNB (T-eNB) 107. The handover request message may include information required for the T-MeNB 107 to make a decision as to whether it can accept the UE for handover. This information may include the resources required by the UE. For example, the information may include quality of service (QoS), UE capability and/or S-MeNB 106 and S-SeNB 105 configuration. In the case of non-bearer splitting, the information may further include information that will allow the T-ENB to take over communication with the MME/S-GW 112a from the S-SeNB 105, for example the S-SeNB uplink Fully Qualified Tunnel Endpoint Identifiers (UL F-TEIDs) with the MME/S-GW 112a. In response to the handover request 2, the T-eNB 107 may respond with a handover request acknowledgement message at step 3. This message may include information to allow the S-MeNB 106 to handover to the T-eNB 107. For example, the handover request acknowledgement message 3 may comprise T-eNB configuration information and/or information used by the S-MeNB 106 to forward packets to the T-MeNB 107, for example F-TEIDs for the T-eNB 107.

In response to the handover request acknowledgement message 3, the S-MeNB 106 sends the S-SeNB 105 a release request message 4. The release request message may identify the resources that the S-SeNB had reserved for the UE 102 and indicate that these should be released. It will be appreciated however that the identified resources may not yet be released by the S-SeNB 105. The identified resources may be fully released on receipt of a release complete message at step 20. In the case of non-data splitting, the release request message 4 may include for example information to allow the S-SeNB 105 to forward packets to the S-MeNB 106. For example, the message 4 may comprise F-TEIDs for the S-MeNB 106. The S-SeNB 105 may respond to the release request message 4, with a release response message to the S-MeNB 106 in step 5. In this step, the UE content may still be retained in the S-SeNB 105 until the S-SeNB 105 receives a release complete message (step 20). The UE 102 traffic may be retained until it is confirmed that the traffic is being dealt with elsewhere as opposed to just being dropped.

At step 6, the S-MeNB 106 may send a reconfiguration message to the UE 102. This message may indicate to the UE 102 that the T-eNB 107 is to become the serving base station and that S-SeNB 105 and S-MeNB 106 are released. This message may be for example a radio resource control (RRC) message, for example a RRCConnectionReconfiguration message, and may include some of the information received in the handover request acknowledgement at step 3. The UE 102 may now switch the data transmission from the S-SeNB 105 and S-MeNB 106 to the T-eNB 107.

In order to avoid loss of data during handover, the handover procedure may further include steps 7 to 10.

In the case of non-bearer splitting, at step 7, the S-SeNB 105 may send a status transfer message, for example an sequence number (SN) status transfer message, to the S-MeNB 106. During handover, the S-SeNB starts forwarding data to the S-MeNB and the status transfer message may provide information to the S-MeNB to allow the S-MeNB to start transmitting the data that the S-SeNB had previously been transmitting to the S-GW 112a. This message may include for example in the case of an LTE system, uplink packet data convergence protocol sequence numbers (PDCP SN) and hyper frame number (HFN) receiver status and downlink PDCP SN and HFN transmitter status of S-SeNB 105. It will be appreciated that step 7 may be omitted for bearer splitting as the S-MeNB would already be transmitting the data from the S-SeNB.

At step 8, the S-SeNB 105 may forward data to the S-MeNB 106. Again, this procedure will occur in the case of non bearer splitting. This data may be data received from the network and destined to the UE 102. At the point of step 8, the S-SeNB 105 may not be able to send this data to the UE 102 as the UE 102 has already been disconnected from the S-SeNB 105 (at step 6). The data is forwarded to the S-MeNB 106 which may forward the data to the target eNB (T-eNB) 107.

At step 9, the S-MeNB 106 may send a status transfer message to the T-eNB 107. This message may include the uplink PDCP SN and HFN receiver status and the downlink PDCP SN and HFN transmitter status of S-MeNB 106. Similarly to step 7, this message may provide information to the T-eNB 107 that will allow it to take over the transmitting of UE 102 data from the S-MeNB 106.

At step 10, the S-MeNB 106 may forward data to the T-eNB 107. In some embodiments, the S-MeNB 106 may forward the data received from the S-SeNB 105. The T-eNB 107 may buffer these forwarded packets from S-MeNB 106 until a reconfiguration complete message, for example a RRC Connection Reconfiguration Complete message, is received at the T-eNB 107. The reconfiguration complete message may indicate to the T-eNB 107 that reconfiguration is now complete.

After the UE 102 receives the reconfiguration message at step 6 indicating that T-eNB 107 is added and the S-MeNB 106 and S-SeNB 105 have been released, the UE 102 may perform a random access procedure towards the T-eNB 107. The random access procedure is carried out to set up the communication between the T-eNB 107 and the UE 102. Random access (the MAC layer) provides the initial access between the UE 102 and the T-eNB 107.

After performing the random access procedure, the UE 102 may send a reconfiguration message response to the T-eNB 107 indicating that reconfiguration is complete. This is shown at step 11. The message may be for example a RRCConnectionReconfigurationComplete message.

At step 12, packet data may be transferred from the UE 102 to the S-GW 112a by passing through T-eNB 107. However, the S-GW 112a needs to be informed of the new arrangement—that the T-eNB 107 is now on the path for data to the UE 102.

At step 13, the T-eNB 107 may inform the core network, in this case the MME 112a, that the path from the core network to the UE 102 has changed. In this example, the T-eNB 107 may send a path switch request message to the MME 112a. It will be appreciated that in some embodiments, this message may be sent to an entity that includes both the MME and S-GW. This message informs the MME and S-GW that the path has been modified and directs packets for the UE 102 to the T-eNB 107. The path switch request message may include information to allow the core network to continue the data transmission with the T-eNB 107, for example downlink F-TEIDs of the communication with the S-GW 112a.

At step 14, in the cases where the MME and S-GW are not a single entity, the MME informs he S-GW of the change of path. In this example, the MME 12a may send a modify bearer request message to the S-GW. This message may include for example both T-SeNB downlink F-TEIDs with S-GW. It will be appreciated that in embodiments where the functionality of the MME and S-GW are carried out by a single entity, this step will be omitted.

At steps 15 and 16 the core network will modify the path to the UE 102 in response to message 14 and/or 13. This includes modifying the path that had been to the S-MeNB 106 (step 15) and modifying the path that had been to the S-SeNB 105 (step 16) to now be directed to the T-eNB 107.

In this example at step 15, the S-GW 112a may switch the downlink data path previously served by the S-MeNB 106 to the target side (T-eNB 107). The S-GW 112a may additionally for example send one or more “end marker” packets on the old path to the S-MeNB 106 and release any U-plane/TNL resources towards the S-MeNB 106. Downlink packets from the S-GW 112a may now be sent through the T-eNB 107 to the UE 102.

In this example at step 16, the S-GW 112a may switch the downlink data path previously served by the S-SeNB 105 to the target side (in this case the T-eNB 107). The S-GW 112a may additionally send for example one or more “end marker” packets on the old path to the S-SeNB 105 and then release any U-plane/TNL resources towards the S-SeNB 105. It will be appreciated that step 16 will occur for non-bearer splitting as in bearer splitting the core network will only have a path to the S-MeNB 106.

At steps 17 and 18, the core network confirms that the path has been updated to the T-eNB 107.

In this example at step 17, the S-GW 112a may send a modify bearer response message to MME 112a to inform it that the bearer has been modified. It will be appreciated that this step may be omitted when the MME and S-GW are combined.

In this example, at step 18, the MME 112a may respond to the path switch request message with a path switch request acknowledgement message send to the T-eNB 107.

At step 19, the T-eNB 107 informs the S-MeNB 106 that it has received the UE 102 and that the handover is complete. In this example the T-eNB 107 may send a UE context release message to the S-MeNB 106. By sending the UE context release message, the T-eNB 107 may inform the S-MeNB 106 of a successful handover. This message may also trigger the release of resources by the S-MeNB 106 and the S-SeNB 105. The T-eNB 107 may send this message in response to a receipt of the path switch request acknowledgement message.

At step 20, the S-MeNB 106 may inform the S-SeNB 105 of the successful handover and that resources can now be released. In this example, the S-MeNB 106 may send the S-SeNB 105 a release complete message to release the radio resources for the UE 102 held at the S-SeNB 105.

FIG. 4 describes a handover procedure of a UE 102 between a serving base station 106 and a target base station 107. It will be appreciated however that such procedures are not always successful. For example a handover may fail. Handover procedures may fail at various points through the procedure. For example in the steps of FIG. 4, the procedure may fail at any point through steps 3 to 11.

If the handover procedure fails, it may be required that the UE 102 re-establishes communication with a serving base station (S-MeNB 106). A handover failure is only one example of a failure that will trigger a re-establishment procedure with the UE. It will be appreciated that there may be other triggers or causes to having to carry out re-establishment. For example, in some cases there may be failure of a link between a UE 102 and serving base station 107 and the communication or connection between these two entities will need to be re-established.

Re-establishment may be carried out in order to establish a radio resource control (RRC) connection with the UE. In some examples this RRC connection may be a signalling radio bearer 1 (SRB1) connection that will allow RRC messages to be sent between the UE and eNB and allow radio resource control to be carried out.

In some communication systems re-establishment may be carried out as follows:
1. A UE that has lost a link, for example due to link failure or a handover failure, may send a connection re-establishment request to a serving or source base station. This request may be for example a RRC Connection Reestablishment Request. The RRC Connection Re-establishment Request may be send over a resource (for example a signalling resource bearer 0 (SRB0) that has been reserved for such requests).
2. The source base station may first identify if it has an old UE context corresponding to the UE (for example based on information such as a UE identity in the request). If the re-establishment is due to a failure for at handover for example, it is likely that the source base station may have a UE context even if that context is indicated as belonging to UE in the process of being handed over. If the source base station can find a UE context for the UE, it may create a new UE context and copy the serving context to the target context.
3. The source base station may send a handover cancel message to the target base station if handover had already been triggered before failure. This may allow the target base station to exit the handover procedure.
4. The source base station may create a connection between the source base station and the core network (for example the MME/S-GW) for the user equipment. In some cases this may comprise switching the failed connection between a base station and the core network for the UE to be between the source base station and the core network. For example in an LTE system, this will be the S1 connection.
5. The source base station may additionally delete any forwarding route for data to the target eNB. For example, the source base station may delete a GPRS Tunnelling Protocol (GTP) route for data forwarding to the target eNB.
6. The radio link control (RLC) and PDCP layers may be re-established for a radio bearer between the source base station and the UE. This will provide a resource over which the eNB may carry out RRC control. In this example, these layers will be re-established for the signalling radio bearer 1 (SRB1).
7. Any buffered data may be transferred from the old UE context to the new UE context
8. A connection re-establishment message, for example a RRC Connection Re-establishment may be sent to the UE. This message may contain configuration information required by the UE to re-establish a radio resource control connection between the UE and the eNB. For example, the UE may re-establish PDCP, RLC for SRB1, update security keys and may resume signalling on the SRB1
9. The UE may send a connection re-establishment complete message, for example an RRC Connection Restablishment Complete, to the source base station.
10. As the RRC control connection is established, the source base station may send a message to the UE over the established connection to configure radio bearers for communication between the source base station and the UE. The source base station may send a reconfiguration message, for example an RRC Connection Reconfiguration, to the UE with data resource bearers (DRB) configurations for the communication. This message may be sent over the established connection, for example the SRB1
11. In response, The UE may send a reconfiguration complete message, for example a RRC Connection Reconfiguration Complete message, to the source base station indicating that it has configured the DRBs and may resume the DRB transmission. It will be appreciated that this message may also be send over the established connection, for example the SRB1 connection.

When this re-establishment procedure is extended for dual connectivity (DC) Architecture, for example to allow the UE to trigger re-establishment with the S-MeNB, the data from/to the S-SeNB may be lost without additional coordination between the MeNB and the SeNB during re-establishment.

The present application aims to provide a re-establishment mechanism that preserves data from/to the S-SeNB. Some embodiments additionally aim to realize a fast re-establishment mechanism in case of DC (Dual Connectivity) operation.

In embodiments, in response to a request for re-establishment from a UE, the master base station may send an indication that re-establishment has been requested to a secondary base station. In some examples, at this point, if the master base station had been forwarding data packets (for example to a target base station in a handover procedure) the master base station will stop forwarding the packets and start buffering them instead.

The secondary base station may respond to the indication from the master base station by sending the master base station configuration parameters of the secondary station. These configuration parameters may be parameters that the UE requires in order to carry out reconfiguration of communication with the secondary base station. These parameter may also contain information to trigger a contention free RACH-Access procedure with the secondary base station as part of reconfiguration procedure.

For example the parameters may relate to secondary cell group (SCG) configuration parameters. These parameters may be for example a media access control (MAC) layer or physical (PHY) layer parameters, and/or may relate to the data resource bearers (DRB).

It will be appreciated that first a re-establishment procedure is carried out to re-establish communication (for example on a radio resource control plane) between the UE and the master base station. After the link between the UE and master base station is re-established, a reconfiguration procedure may be carried to reconfigure the communication (for example to configure radio bearers to be used for user and/or control data) between the UE and the secondary base station. The master base station may trigger this reconfiguration by sending a reconfiguration request message to the UE and include the reconfiguration parameters of the secondary base station in the request.

By sending an indication to the secondary base station when a re-establishment request is received, the master base station can request or trigger the secondary station to send the secondary base station (re)configuration parameters to the master base station. The master base station may store these parameters during the re-establishment procedure and then use them to request reconfiguration from the UE.

In these embodiments, the UE may re-establish a radio resource control connection with a master base station and reconfigure a connection for user data between the UE and a secondary base station. It will be appreciated that in some embodiments, the UE may also reconfigure a connection for user data between the UE and master base station. The triggering of a request for configuration parameters from the secondary base station on receipt of a request for re-establishment may allow the master base station to include the configuration parameters of the secondary base station in a reconfiguration request to the UE.

In particular, some embodiments may be applicable in the re-establishment triggered at a source MeNB due to handover or reconfiguration failure scenarios. The message sent to the SeNB from the MeNB (triggering the SeNB to send the MeNB the SeNB's configuration parameters) may be a SCG modification message. In some embodiments, the SCG modification message may correspond to an existing SCG modification message with an additional parameter to indicate to the SeNB that a request for re-establishment has been received. The SCG modification message may be triggered on reception of re-establishment message from UE.

On reception of the message including an indication of re-establishment (for example a flag), the secondary base station may stop data forwarding (if started) towards the target base station and/or the master base station. The source base station may provide configuration parameters such as the latest SCG MAC and PHY configuration information to be used in a connection reconfiguration message. The source base station may also provide radio access channel (RACH) parameters used for contention free RACH-Access with the source base station during a reconfiguration procedure.

The master base station may send a notification message to secondary base station once the reconfiguration procedure is complete. The message may indicate that the secondary base station may resume secondary base station scheduling to resume the data operations of the secondary base station.

In an additional embodiment, the re-establishment and reconfiguration procedure may be modified to resume data communication as quickly as possible. In this case, the UE may store information regarding the master and secondary base station configuration parameters and use these to speculatively perform a RACH access procedure towards the secondary base station before the configuration parameters of the secondary base station are received in the connection reconfiguration message from the master base station.

In particular in some embodiments, the UE may store information about the primary and secondary cell before triggering a re-establishment procedure for link failure. It will be appreciated that the primary cell may be a cell served or supported by the master (or primary) base station and the secondary cell may be a cell served or supported by the secondary base station. The primary and secondary cell information may include in some embodiments the current secondary primary cell (SPCell) or secondary base station details and/or information relating to PRACH resources and/or the current primary cell identity (PCell ID) in the case that the primary call has bearers mapped to secondary cell group (SCG).

It will be appreciated that reference here has been made to a SPCell. The secondary cell group (the cells served by the secondary base station) may have a cell (the SPCell) that is used as an uplink timing reference.

On reselecting a new cell for re-establishment, if the physical cell identity (PCI) and cell-identity of the new call matches with the source primary cell and the stored information includes SCG bearers (for example if the UE stored parameters indicate a dual connectivity with a primary cell and secondary cell), the UE may start a RACH-Access to the secondary cell along with the re-establishment procedure. The UE may then store the uplink timing information and if the connection reconfiguration message after re-establishment contains the same secondary primary cell, then the UE may start accessing the secondary base station based on the timing data obtained from earlier RACH Access.

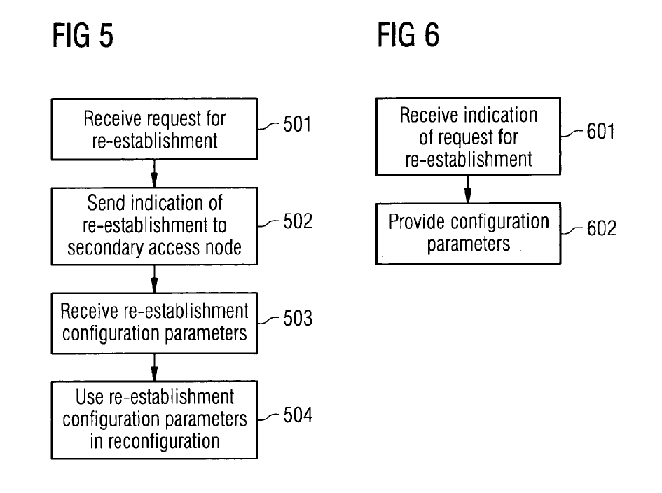

FIG. 5 shows an example of the method steps that may be carried out by a master or primary base station in accordance with some embodiments. At step 501 of FIG. 5, a request for re-establishment is received at a master base station. The request for re-establishment may be received from a UE and may be requested in response to for example a link or handover failure. In some embodiments, the request may be an RRC Connection Reestablishment Request. This may be a request to re-establish a radio resource control connection (for example an SBR1 connection) between the UE and the master base station.

At step 502, the master base station may provide an indication to a secondary base station that re-establishment has been requested. The master base station and secondary base station may be configured for dual connectivity (DC) with the UE. The sending of the indication to the secondary base station may be triggered by the receipt of the request for re-establishment. In one example, the indication that re-establishment has been requested may be in the form of a secondary control group (SCG) modification message. The indication itself may for example be a flag set within a SCG modification message.

At step 503, the master base station may receive a message from the secondary base station including configuration parameters of the secondary base station. The configuration parameters may correspond to parameters used by the UE in a reconfiguration procedure with the secondary base station. For example the configuration parameters may be SCG configuration parameters. The parameters may include information for example such as a current MAC or PHY configuration of the secondary base station. It will be appreciated that the master base station may be able to store these parameters. It will also be appreciated that the configuration parameters received from the secondary base station may not be needed by the master base station in response to the request for re-establishment. Once the indication that a request for re-establishment has been triggered, the master base station may continue with a re-establishment procedure and may not wait until a response is received from the secondary base station. The master base station may however wait for a response from the secondary base station before sending a reconfiguration request as the configuration parameters may be included in the reconfiguration request.

At step 504, the master base station may send the configuration parameters of the secondary base station to the UE in a connection reconfiguration message. This message may instruct the UE to carry out a reconfiguration procedure with respect to data radio bearers of the secondary base station. The reconfiguration may be carried out to configure radio resource bearers between the UE and the master base station and/or secondary base station. The re-establishment procedure may have been carried out to set up a radio resource connection over which the resource bearers may be set up using the reconfiguration procedure. In some examples, the resource bearers are set up for carrying user traffic between the UE and the master and/or secondary base station.

In an example the reconfiguration message may be a RRC Connection Reconfiguration message. It will be appreciated that message may be sent when a re-establishment has been carried out for example, the master base station and the UE may re-establish a signalling resource bearer connection (for example SRB1), after which reconfiguration may be initiated.

FIG. 6 is a flow diagram showing an example of the method steps carried out by a secondary base station in accordance with some embodiments.

At step 601 of FIG. 6, the secondary base station receives from the master base station, an indication of a request of re-establishment from the UE.

At step 602, the secondary base station sends a message to the master base station comprising configuration parameters of the secondary base station. The master base station may use these parameters in a connection reconfiguration request to the UE. If the secondary base station was forwarding packets, for example in accordance with a handover procedure, the secondary base station may stop forwarding packets in response to the indication of the request for re-establishment.

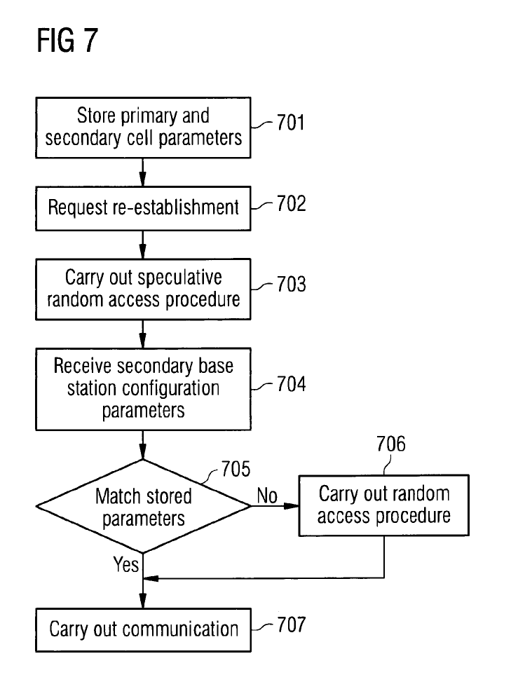

FIG. 7 is a flow diagram showing the method steps that may be carried out by a UE in accordance with some embodiments.

It will be appreciated that steps 701, 703, 705 and 706 of FIG. 7 may be in accordance with a further embodiment of the present application and thus may be omitted in some embodiments.

At step 701, the UE may store parameters relating to the primary and secondary cells of the communication system. These parameters may be for example details of the primary and secondary cell (served by the master and secondary base station respectively) such as an identity of the cell and other PRACH resource information that would be used for a reconfiguration procedure.

At step 702, the UE requests re-establishment from a master base station.

At step 703, if the identity of the master base station matches the stored identity (in other words if the UE has reason to suspect it has already stored the details of the base station to which it is requesting re-establishing) the UE may carry out a speculative radio access procedure. The random access procedure may be carried out with respect to the secondary base station, for example for a secondary primary cell (SPCell), using a configuration for a SPCell that was stored as the parameters at step 701. It will be appreciated that in this case, the parameters stored related to a SPCell of the system, for example served by the secondary base station. The parameters may be random access channel (RACH) parameters. At step 704, the UE may receive the secondary base station configuration parameters from the master base station and may determine whether the received parameters match the stored parameters at step 705.

If the parameters do match, the UE may assume that it has already carried out the speculative random access procedure for the correct parameters and may proceed to transmit and receive data accordingly at step 707. If the parameters do not match, then the UE carried out the random access procedure using incorrect or stale parameters and carries out a second random access procedure using the received parameters at step 706. The method may then proceed to step 707.

It will be appreciated that the mechanism of carrying out a speculative random access procedure may be in accordance with further embodiments only. In some cases, the UE will not pre-store parameters and carry out speculative random access procedures. In these embodiments, the UE will carry out the method steps 702, 704 and 707 and will omit steps 701, 703, 705 and 706.

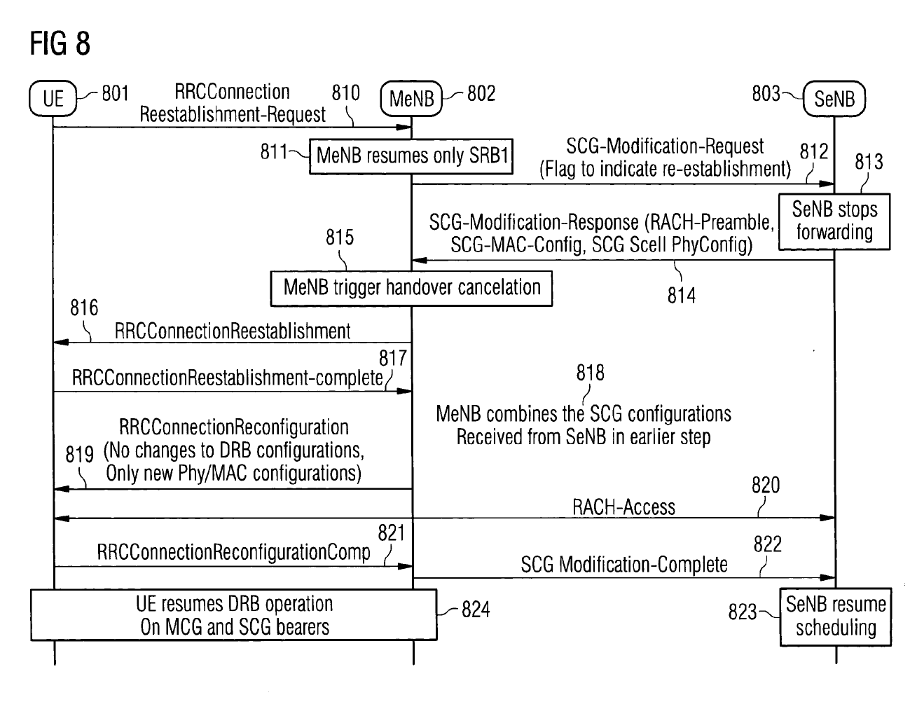

FIG. 8 is a signal flow diagram showing the signalling according to a first embodiment. In this embodiment, the secondary base station provides configuration parameters to the primary base station in response to an indication that a re-establishment request has been received from the UE.

In the example of FIG. 8 a first phase of re-establishment involves the re-establishment of a radio resource control connection, for example the signalling resource bearer SRB1, between the UE and the master or primary base station. A second phase involves a connection reconfiguration to set up or reconfigure radio bearers between the UE and the primary and/or secondary base station. It will be appreciated that the reconfiguration procedure may make use of the control connection established in the re-establishment procedure. Once the control connection is established in the first phase, the connection reconfiguration is carried out to establish and/or modify radio bearers between the UE and the secondary and/or primary and secondary base stations.

The first phase is described in relation to steps 801 to 817 of FIG. 8.

At step 810, a UE may send a re-establishment request to a master base station 802.

At step 811, the master base station 802 may, in response to the re-establishment request, prepare to re-establish a radio resource control connection (for example SBR1) with the UE. At this point, the master base station 802 may carry out other re-establishment related actions such as stop forwarding data packets to a target base station.

The master base station 802 may also send an indication that a request for re-establishment has been received to the secondary base station in response to the message 810. This is shown at step 812. In this example, the indication may be sent as part of a SCG modification request message comprising a flag that may be set to indicate that a request for re-establishment has been received however it will be appreciated that the indication may take a different form.

In response to the indication at step 812, the secondary base station 803 may stop forwarding data at step 813. It will be appreciated that in some embodiments, the forwarding of data may have been carried out by the secondary base station 803 in response to handover preparation and step 813 only occurs if the secondary base station 803 was forwarding data.

At step 814, the secondary base station may respond the message received at step 812 by providing configuration parameters of the secondary base station 803. The configuration parameters may be parameters that the UE requires in order to carry out connection reconfiguration with the secondary base station. The parameters may also include information to allow the UE 801 to carry out a random access procedure with the secondary base station 803. The parameters may for example include a SCG configuration and/or MAC and Phy configuration details. It will be appreciated that in some embodiments, the secondary base station 803 will only send the configuration parameters that have changed since they were last reported to the master base station. In this example there may be no change to the data resource bearers (DRBs) of the secondary base station. The master base station 802 may store this configuration information from the secondary base station 803.

At step 815, the master base station may trigger a handover cancel procedure to target base station if necessary. This step may be carried out in the case that the re-establishment is in response to a failed handover and that a handover request had been sent.

At step 816, the master base station 802 may respond to the re-establishment request. As discussed at step 811, in the response to the re-establishment request, the master base station 802 is re-establishing a radion resource control connection between the master base station 802 and the UE 801. In response the re-establishment request 810, the master base station may reply with configuration information for the master cell (the cell served by the master base station 802) only. This configuration information may be for example the configuration of the signalling resource bearer and MAC and PHY configuration for the master cell. In an example, the response to the re-establishment request may be a RRCConnectionReestablishment message.

At step 817, the UE may reply to the response to the re-establishment request to indicate that re-establishment is complete. In some examples, this may be a RRCConnectionReestablishment-complete message.

The second phase of re-establishment procedure—namely the connection reconfiguration may be carried out by steps 818 to 824. In this phase, radio bearers are set up between the UE 801 and the master base station 802 and/or secondary base station 803 so that the UE 801 can start communicating user data to and from the network.

The master base station may trigger connection reconfiguration to reconfigure and establish data resource bearers (and their mappings) between the UE and the master and secondary base stations. If, as per the UE context mapping the current configuration contains MCG and SCG bearers and if the same bearers are continuing, the connection reconfiguration may not contain any DRB-modifications and only contain new Phy configuration including MCG and SCG cells and MAC-Configurations for MCG and SCG. In this example only new configuration was passed to the master base station by the secondary base station and the case where only the MAC and Phy configuration has changed will be discussed below.

At step 818, the master base station 802 may combine the changed configuration information from the message received at step 814 with stored configuration information for the secondary base station 803. In other words, the master base station 802 may update the configuration information for the secondary base station 803 based on the message received at 814. For example the message at 814 may comprise new MAC and PHY configuration information

At step 816, the master base station may trigger connection reconfiguration by sending the UE 801 a request for reconfiguration. The request may include the configuration information of the secondary base station. The request may be a RRConnectionReconfiguration message in some embodiments.

In response to the request, the UE 801 may carry out a random access procedure at step 820. For resuming the bearers mapped to the secondary base station 803, the UE may complete a random access procedure (for example RACH Access) towards the secondary base station.

It will be appreciated that the UE 801 may have carried out a random access procedure with or towards the master base station as part of the re-establishment procedure, for example during the sending to the RRC-Reestablishment-Request itself. During the reconfiguration procedure, the DRBs of master base station may be resumed without a random access procedure. During the reconfiguration procedure however, the MAC and PHY layer between the UE 102 and secondary base station 803 may be reconfigured. A random access procedure is carried out with the secondary base station in order to resume DRB with the reconfigured MAC and PHY layers.

At step 821, the UE 801 may send a connection configuration complete message to the master base station 802 if the random access procedure was successful. On receipt of the connection reconfiguration complete message (for example the RRCReconfiguration-complete) the master base station may resume its scheduling and also send the secondary base station 803 a message to indicate that the reconfiguration is complete at step 822. The indication may form part of a SCG modification-complete message for example.

At step 823, the secondary base station may resume its scheduling in response to the message 822.

At step 824, the UE 801 may resume operation on the master and secondary cell group bearers.

By sending an indication that re-establishment has been requested in response to re-establishment being requested, the secondary base station can be informed to stop forwarding packets (if it is) and the second base station may send its configuration parameters to the master base station. The master base station may send a reconfiguration request to the UE including the secondary base station configuration information without having to query for secondary base station configuration information on receipt of a re-establishment-complete message.

It will be appreciated that the random access procedure may in some embodiments be triggered based on data-availability at the time of re-establishment. For example, it can be triggered whenever uplink and/or downlink data transmission is needed.

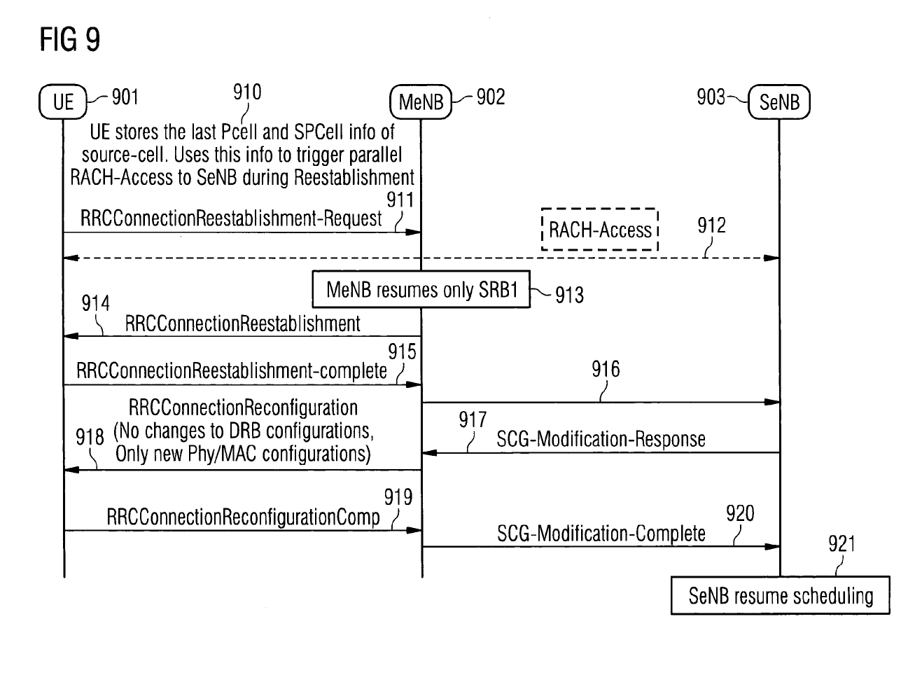

FIG. 9 is a signal flow diagram showing the signalling according to a second embodiment. In this embodiment, the UE may carry out a faster re-establishment by speculatively carrying out a RACH procedure based on stored parameters. It will be appreciated that in the embodiment of FIG. 9 may be carried out in conjunction with the embodiment of FIG. 8, namely the request for re-establishment may trigger an indication to be sent to the secondary base station. In other examples, such as in the steps set out in FIG. 9, the sending of the indication may not be triggered by the request for re-establishment.

FIG. 9 shows the signalling between a UE 901, master base station 902 and secondary base station 903.

At step 910, the UE stores configuration information for a primary and secondary cell that it is being served by before for example a link between the UE 901 and primary and secondary cell is lost or a handover failure towards a target cell. This configuration information may be for example master/secondary cell details along with information related to random access channel resources for the cell if it has bearers mapped to the SCG. This information may also include a cell-identity of the master or primary cell.

At step 911, the UE 901 may send a request for re-establishment. This may be for example similar to request 810. At step 913 the master base station may resume a radio resource control connection. This may be similar to step 811 of FIG. 8.

At step 912, if the stored configuration parameters identifying a master cell (for example the PCI (Physical Cell Identity) and cell-identity) match the identity of the master base station 902 selected by the UE 901 to request re-establishment from, and the stored configuration has secondary cell group bearers, the UE 901 may start a random access procedure towards the secondary cell group (in this case secondary base station 903) when it requests re-establishment. In this case, the UE 901 may suspect that it already has the configuration parameters needed for connection reconfiguration stored.

The re-establishment procedure may be completed at steps 914 and 915 which may be similar to steps 816 and 817 in some embodiments. It will be appreciated that while the master base station 902 is shown as requesting the configuration parameters of the secondary base station 903 at steps 916 and the subsequent response in 917, these steps may be carried out in response to the receipt of the re-establishment request as in FIG. 8 in some embodiments. It will be appreciated then that steps 916 and 917 may be similar to steps 812 and 814 of FIG. 8.

The secondary base station may complete the (speculative) random access procedure without data transmission. The UE 901 may store the uplink timing info obtained.

At step 918, the master base station 902 may send a connection reconfiguration request to the UE 901 comprising configuration information for the secondary base station 903. If the configuration information of the secondary base station 903 matches that stored at the UE 901 (and for which the speculative random access procedure was carried out) the UE 901 may connect with the secondary base station 903 immediately. For example, if secondary base station configuration information indicated the same secondary/primary cell (SPCell) for which the speculative random access procedure was carried out, then the UE 901 may start accessing the secondary base station 903 based on the TA (Timing Advance) obtained from the speculative random access procedure.

At step 919, the UE 901 may send a reconfiguration complete message to the master base station 902 and this may be passed to the secondary base station 903 at step 920. The secondary base station 903 scheduling may then be resumed.

It will be appreciated that the foregoing describes the indication of re-establishment as being a modified SCG modification procedure. SCG Modification procedure may be a procedure which changes a SCG resource configuration. During a re-establishment procedure the SCG modification procedure may be used to indicate that the UE is re-establishing a connection. Prior to this procedure the secondary base station may have marked the resources allocated to the UE for release, stopped scheduling for the UE and started forwarding.

The secondary cell group (SCG) modification procedure may be initiated by the secondary base station and used to perform configuration changes of the secondary cell group within the same secondary base station. During the SCG Modification procedure:

1. The secondary base station may provide a new radio resource configuration of SCG in a radio resource control (RRC) container in a SCG Modification Request message.

2. The master base station may send a RRCConnectionReconfiguration message to a UE including the new radio resource configuration of SCG according to the SCG Modification Request message.

3. The UE may apply the new configuration and reply with the RRCConnectionReconfigurationComplete message. If synchronisation towards the secondary base station is not required for the new configuration, the UE may perform uplink (UL) transmission after having applied the new configuration. If the new configuration requires synchronisation towards the secondary base station, then the UE may perform a Random Access procedure.

4. The master base station may reply with a SCG Modification Response to the secondary base station. This response may forward the RRCConnectionReconfigurationComplete message.

In embodiments of the present application, the master base station may be triggered to send a SCG modification message to the secondary base station and include in it information (for example a flag) indicating the a re-establishment request has been received. This may trigger the secondary base station to send SCG configuration information to the master base station.

It is noted herein that while the above describes exemplifying embodiments of the invention, there are several variations and modifications which may be made to the disclosed solution without departing from the scope of the present invention.

It will be appreciated that while the foregoing uses the term base station, it will be appreciated that the base station may be a network node to provide access to a user equipment to a network. The base station may be a node B, e Node B and/or a base transceiver station in some embodiments. Some embodiments have been described in relation to LTE in which case the base station will be an eNode B.

It will be appreciated that while the foregoing uses the term user equipment, it will be appreciated that the user equipment may be any communication device for accesses a network. A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

The required data processing apparatus and functions of a base station apparatus, a communication device or user equipment and any other appropriate station may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments may be implemented by computer software executable by a data processor of the communication device, such as in the processor entity, or by hardware, or by a combination of software and hardware.

The applicant draws attention to the fact that the present invention may include any feature or combination of features disclosed herein either implicitly or explicitly or any generalisation thereof, without limitation to the scope of any definitions set out above. In addition to the modifications explicitly mentioned above, it will be evident to a person skilled in the art that various other modifications of the described embodiment may be made within the scope of the invention.

1-25. (canceled)

26. A method comprising:
receiving at a primary access node a request for re-establishment of a connection; and sending to a secondary access node a request for configuration information in response to the request for re-establishment.

27. The method of claim 26 wherein the request for re-establishment is received from a user equipment.

28. The method of claim 26 wherein sending the request for configuration information is triggered by the receiving the request for re-establishment.

29. The method of claim 26 further comprising: sending a request for connection reconfiguration to the user equipment from the primary access node, the request for connection reconfiguration comprising the configuration information of the secondary access node.

30. The method of claim 29 wherein the method further comprises: receiving an indication from the user equipment that re-establishment is complete before sending the request for connection reconfiguration.

31. The method of claim 26 wherein the sending the request for configuration information to the secondary access node further comprises: sending the secondary access node an indication that a request for re-establishment has been received.

32. The method of claim 26 wherein the request for re-establishment is a radio resource control connection re-establishment request.

33. The method of claim 31 wherein the indication is sent in a secondary cell group modification request message.

34. The method of claim 29 wherein the request for connection reconfiguration is a radio resource control connection reconfiguration request.

35. The method of claim 26 wherein the configuration information comprises the configuration parameters of the secondary access node that are required for a random access procedure between the user equipment and the secondary access node.

36. The method of claim 35 further comprising: updating stored configuration information for the secondary access node with the configuration information received from the secondary access node.

37. The method of claim 26 wherein in response to receiving the request for re-establishment the method further comprising: disabling forwarding of data packets by the primary access node.

38. A method carried out by a secondary access node comprising:
receiving from a primary access node, an indication that a request for re-establishment of a connection has been received at the primary access node from a user equipment; and sending configuration information of the secondary access node to the primary access node.

39. The method of claim 38 wherein the indication forms part of a secondary cell group modification request message and the configuration information is sent in a secondary cell group modification response message.

40. The method of claim 39 further comprising: scheduling data communication in response to an indication that a reconfiguration procedure between a user equipment and the secondary access node is complete.

41. The method of claim 38 wherein in response to receiving the indication the method further comprising: disabling forwarding of data packets by the secondary access node.

42. A method comprising:
sending a request for re-establishment of a connection to a primary network access node and carrying out a re-establishment procedure with the primary network access node; receiving a connection reconfiguration request from the primary access node, the connection reconfiguration request comprising configuration information for a secondary network access node.

43. The method of claim 42 further comprising: carrying out a random access procedure with the secondary network access node in dependence on the configuration information of the secondary network access node.

44. The method of claim 42 further comprising: performing a first random access procedure using stored parameters at a user equipment before receiving the connection reconfiguration request from the primary network access node.

45. The method of claim 44 further comprising: comparing the configuration information of the secondary network access node received in the connection reconfiguration request to the stored parameters; and when the stored parameters and the received configuration information match resume communication with the secondary network access node based on the random access procedure.
